(19) United States
(12) Patent Application Publication
(10) Pub. No.: US 2008/0115416 A1
(43) Pub. Date: May 22, 2008

(54) GARAGE DOOR

(76) Inventor: Keith Clark, Kingwood, TX (US)

Correspondence Address: PATTERSON & SHERIDAN, L.L.P., 3040 POST OAK BOULEVARD, SUITE 1500, HOUSTON, TX, 77056, US

(21) Appl. No.: 11/562,508

(22) Filed: Nov. 22, 2006

(51) Int. Cl. E06B 3/50

(52) U.S. Cl. 49/142

(57) ABSTRACT

A method and apparatus for providing an access door within a sectional garage door. The access door allows access to the interior of a building through the sectional garage door without having to open the sectional garage door. The access door is capable of opening by pivoting about a substantially horizontal axis when the sectional garage door is closed. Further, the access door is adapted to pivot with the sectional garage door as the sectional garage door moves to and from the closed position to the open position.

### BACKGROUND OF THE INVENTION

1. Field of the Invention

Embodiments described herein generally relate to an apparatus and method for entering a garage or building through a sectional garage door when the sectional garage door is in a closed position. More particularly, the embodiments disclosed herein relate to an access door within the sectional garage door such that the access door allows access to the interior of the garage or building without opening the sectional garage door. More particularly still, the access door is adapted to pivotably move in a manner similar to the sectional garage door as the sectional garage door moves to and from a closed to an open position.

2. Description of the Related Art

In the construction of buildings, it is known to cover large access ways or openings into the interior of the buildings with sectional garage doors. For example, a residential garage for parking cars or a warehouse will include a sectional garage door which can be opened to allow access to the interior of the building. Sectional garage doors are commonly used in a variety of commercial, industrial, and residential applications. Sectional garage doors typically consist of a series of horizontal sections or panels which are connected to one another along a horizontal axis. The connection between horizontal sections is a hinged connection. The hinges allow the horizontal sections to pivot relative to one another about a horizontal axis. The pivoting allows the sectional door to flex as the sectional door is moved to and from a closed position to an open position.

Each of the horizontal sections spans the length of the entire opening in the building. Each end of the horizontal sections is coupled to one or more rollers. The rollers are adapted to roll within a track, located on each side of the horizontal sections, which guides the movement of the sectional garage door. The rollers are configured to guide and support the horizontal sections. Each track typically comprises a vertical portion, a bend, and a horizontal portion. The vertical portion follows the height of the building opening. Above the opening, the track bends from the vertical portion until it is substantially horizontal. The horizontal portion of the track is typically as long as the vertical portion. When the rollers are located in the vertical portion of the track, the horizontal sections or panels of the sectional garage door substantially cover the opening of the building. In this closed position, the building is inaccessible through the sectional garage door. The sectional garage door in this position is held in place by gravity pulling it down while the track and rollers prevent the horizontal sections from moving horizontally. In order to access the interior of the building the entire sectional garage door must be opened.

To open the sectional garage door, an operator, either manually or with an automatic opener, lifts the sectional garage door. As the sectional garage door moves up, the track guides the rollers thereby guiding the horizontal sections of the sectional garage door. As the rollers encounter the bend, the hinged connection allows each of the horizontal sections to pivot about a horizontal axis. The pivoting allows the substantially flat sectional garage door to pivot and conform to the track bend as the horizontal portions move past the bend. Once past the bend, the rollers are in line, in the horizontal portion of the track. With the rollers thus in line, the horizontal sections of the sectional garage door are substantially planar and are substantially horizontal. The rollers, supported by the track, support each end of the horizontal sections.

The sectional garage door only allows access to the interior of the building by moving the entire sectional garage door, thereby exposing the entire opening into the interior of the building. Sectional garage doors are often cumbersome and difficult to open. Further, if the interior of the building is climate controlled, opening the entire sectional door will cause the loss of the climate controlled air. Many buildings are not equipped with an alternative entrance other than the sectional garage door. Thus, if an individual wants to enter the interior of the building, the individual must open the entire sectional garage door to gain entry.

Therefore, there is a need for an entry into the interior of a building through a sectional garage door, without opening the sectional garage door. There is a further need for an access door adapted to open within the sectional garage door to allow an individual to enter without opening the sectional garage door. There is a further need for an access door which is adapted to open when the sectional garage door is closed and to pivotably move with the sectional garage door as the sectional garage door travels to and from an open and closed position.

### SUMMARY OF THE INVENTION

Embodiments described herein generally relate to an access door for use within a sectional garage door. The access door includes two or more door panels, and a first set of hinges. The first set of hinges pivotably couple each door panel to a door frame. The door frame is coupled to the sectional garage door and the first set of hinges enable the access door to pivot from a first position substantially coplanar to the sectional garage door to a second position extending at an angle from the sectional garage door. The access door further includes a second set of hinges. The second set of hinges are located between two abutting door panels and configured to pivot the door sections about a substantially horizontal axis as the sectional garage door moves between a closed position and an opened position.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a front elevation view of a building having a sectional door according to one embodiment.

FIG. 2 is a front elevation view of a building according to one embodiment.

FIG. 3 is a front elevation view of a building according to one embodiment.

FIG. 4 is a cross sectional view of an access door according to one embodiment.

FIG. 4A is a schematic view of a hinge according to one embodiment.

FIG. 5 is a cross sectional view of an access door according to one embodiment.

FIG. 6 is a cross sectional view of an access door according to one embodiment.

FIG. 7 is a cross sectional view of an access door according to one embodiment.

FIG. 8 is a schematic view of a control system according to one embodiment.

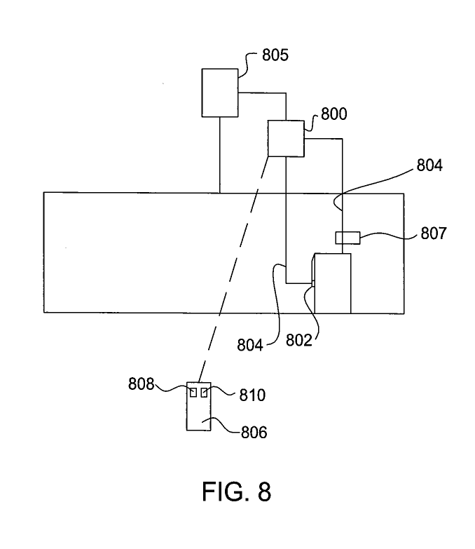

FIG. 9 is a front elevation view of a building according to one embodiment.

FIG. 10 is a front elevation view of a building according to one embodiment.

### DETAILED DESCRIPTION

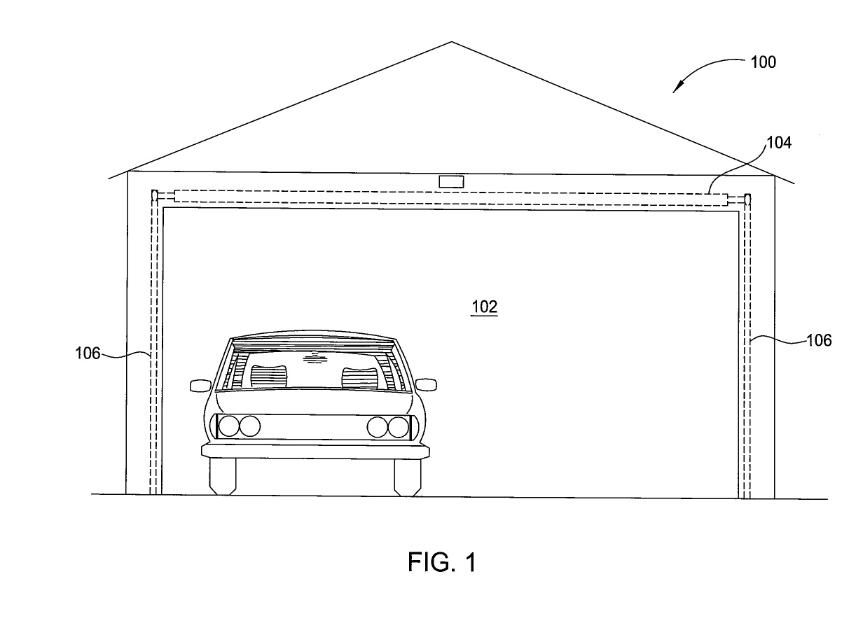

FIG. 1 is a front elevation view of a building 100 according to one embodiment. The building, as shown and described herein, is a residential two car garage; however, it should be appreciated that the building could be any building including but not limited to a warehouse, a three car garage, a one car garage, an office building, a church, a restaurant, a fire station, a police station, a hospital, or a bar. The building 100 has an opening 102 shown as being unobstructed in FIG. 1. The opening 102 is typically a large opening capable of allowing large objects to pass into the building 100, including but not limited to cars, trucks, freight containers, and heavy equipment. A sectional garage door 104 is shown in the open position. The sectional garage door 104, in the open position, is typically located within the building near the top or above the opening 102. The sectional garage door 104 includes an access door, described below, which allows access to the inside of the building 100 when the sectional garage door 104 is in a closed position covering the opening 102. The sectional garage door 104 is supported on each side by tracks 106. The tracks 106 provide support for the sectional garage door 104 in both an opened position and a closed position.

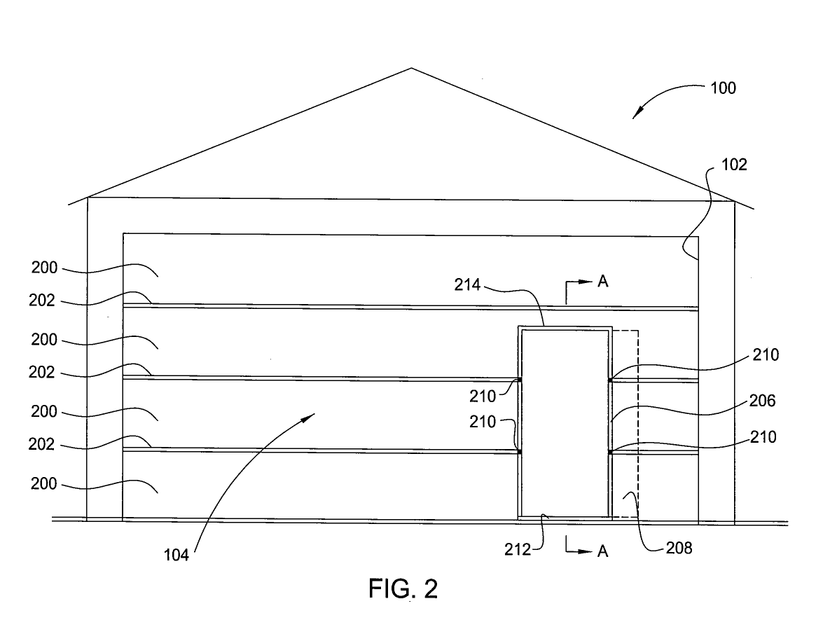

FIG. 2 shows a front elevation view of the building 100, with the sectional garage door 104 in the closed position, according to one embodiment. In the closed position, the sectional garage door 104 substantially covers the opening 102. The sectional garage door 104 consists of a series of horizontal panels 200 or sections. The horizontal panels 200 are connected to one another along a horizontal axis 202. The connection between the horizontal panels 200 is typically a hinged connection. The hinged connection allows the horizontal panels 200 to pivot, relative to one another, about the horizontal axis 202 as the sectional garage door 104 travels to and from the closed position, shown in FIG. 2, to the open position, shown in FIG. 1.

The sectional garage door 104 may include a door frame 206 for supporting an access door 208 as shown in FIG. 2, in one embodiment. The door frame 206 intersects at least two of the horizontal panels 200. The door frame 206 is configured to provide support for the horizontal panels 200 that the door frame 206 intersects. The access door 208 is shown in the open position in FIG. 2 and described in more detail below. With the access door 208 in the open position the sectional garage door 104 has a passage 209 into the interior of the building 100. The door frame 206 has a flexible joint 210 near each intersection of the horizontal panels 200. As shown, there are four flexible joints 210. The flexible joints 210 allow the door frame 206 to pivot with the horizontal panels 200 as the horizontal panels move to and from the opened position to the closed position. The door frame 206 may include a foot plate 212 and/or a top plate 214. The door frame 206, the foot plate 212, and the top plate 214 may be coupled to the horizontal panels 200 or may simply be formed from the horizontal panels 200. The foot plate 212 and the top plate 214 may provide additional structural support to horizontal panels 200. The foot plate 212 may be thin, for example less than ¼″. The thin foot plate 212 rests on the ground when the sectional garage door 104 is in the closed position. The thin foot plate 212 may prevent a user of the access door 208 from tripping when entering the interior of the building 100. The foot plate 212 may be any dimension depending on the requirements of the access door 208.

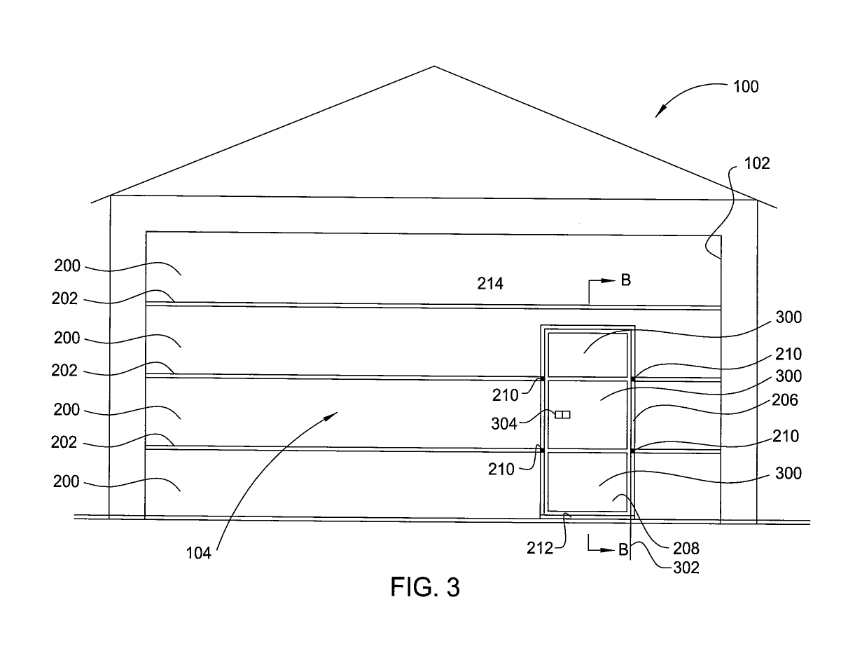

FIG. 3 shows both the sectional garage door 104 and the access door 208 in the closed position. The access door 208, as shown, includes a door section 300 for every horizontal panel 200 that the access door 208 intersects. The door sections 300 may substantially cover the passage 209 when the access door 208 is in the closed position. The door sections 300 pivot relative to one another about the horizontal axis 202. The horizontal pivoting allows the door sections 300 to pivot with the horizontal panels 200 as the sectional garage door 104 moves to and from the closed position and the open position. The door sections 300 are pivotably coupled to the door frame 206 in order to allow the access door 208 to pivot about a vertical axis 302 when moving to and from the open position, as shown in FIG. 2, to the closed position, as shown in FIG. 3.

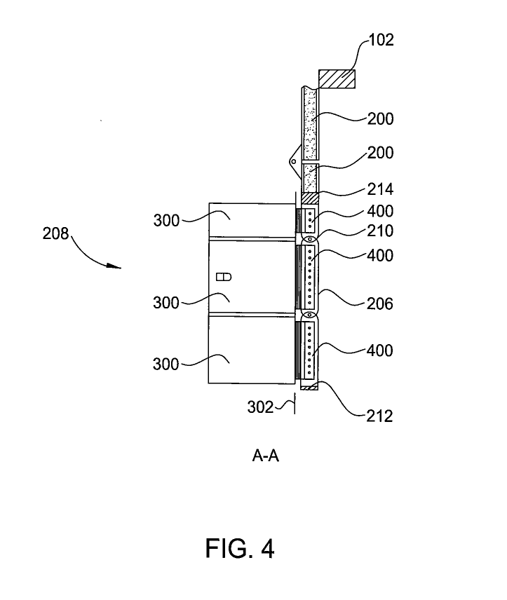

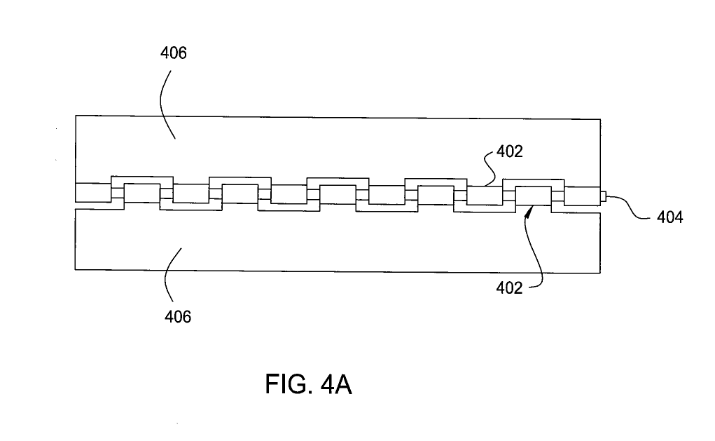

FIG. 4 shows a cross sectional view of the sectional garage door 104 with the access door 208 in the open position. The cross sectional view shows the top of the opening 102, two horizontal panels 200, the foot plate 212, the top plate 214, the door frame 206, the access door 208, and one or more hinges 400 for pivotably coupling the access door 208 to the door frame 206. The hinges 400, as shown, are continuous hinges, or piano hinges, though it should be appreciated that any hinge for coupling the access door 208 to the frame 206 may be used. Continuous hinges increase the strength of the coupling between the door frame 206 and the access door 208. Continuous hinges may be attached to the entire side or be shorter than the door sections 300 and the corresponding door frame 206 segment or horizontal panel 200. A continuous hinge is shown in FIG. 4A. The continuous hinge has a plurality of knuckles 402 that are intersected by a pin 404. The pin 404 allows two leafs 406 to be pivotably coupled to one another. Each leaf 406 is coupled to a surface by a fastener, including but not limited to a screw, a nail, a pin, a bracket, a bolt, or an adhesive. As shown in FIG. 4, one leaf is coupled to the door frame 206 segment and the other leaf is coupled to the door section 300. The continuous hinges are strong throughout their entire length because each of the knuckles 402 is a load bearing point. The load bearing point may thus be along the entire length of the door section 300. The increased strength increases the rigidity of the access door 208 by supporting the full length of the door sections 300. The hinges 400 allow the access door 208 to pivot about the vertical axis 302 from the closed position, shown in FIG. 3, to the open position, shown in FIG. 2. While pivoting about the vertical axis 302, the hinges 400 prevent the door sections 300 from rotating horizontally or pivoting horizontally. Preventing the door sections 300 from pivoting horizontally is caused by the door frame 206, the horizontal panels 200 remaining substantially vertical, which keeps the hinges 400 for each door section 300 substantially vertical and substantially in the same plane as one another. Thus, as the access door 208 opens, the door sections 300 remain substantially in the same plane with one another.

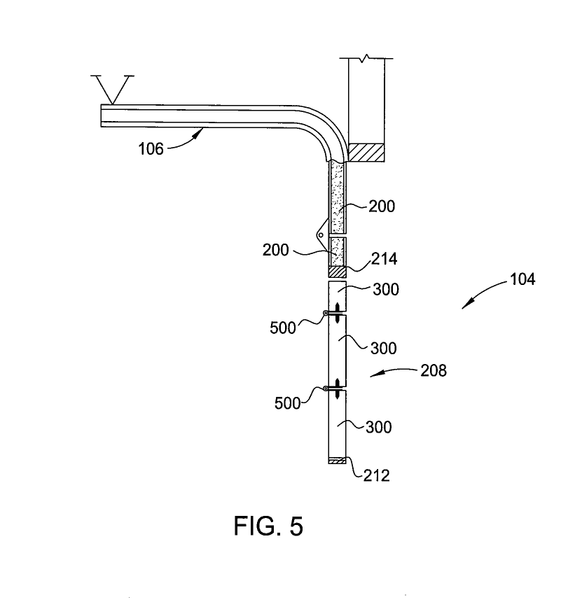

FIG. 5 shows a cross sectional view of the sectional garage door 104 with the access door 208 in the closed position. The access door 208 includes one or more horizontal hinges 500 between the door sections 300. The one or more horizontal hinges 500 pivotably couple the door sections 300 to one another. The horizontal hinges 500 allow the door sections 300 to pivot with the horizontal panels 200 as the sectional garage door 104 moves to and from the closed position to the open position. In one embodiment, the horizontal hinges 500 are continuous hinges, as described above. The continuous hinges allow the connection between the door sections 300 to have increased strength and rigidity. Although shown as continuous hinges, it should be appreciated that the horizontal hinges 500 may be any type of hinge such as, but not limited to, pivot hinges, Mortise hinges, butterfly hinges, flush hinge, coach hinge, double action spring hinge, tee hinge, or friction hinge.

In one embodiment, the hinges 400 and/or the horizontal hinges 500 may be spring loaded or biased. Thus, the hinges 400 would be biased to move the access door 208 toward the closed position, shown in FIG. 3. The one or more horizontal hinges 500 may be biased to move the door sections 300 toward a position where the door sections 300 are substantially in line, or planar, as shown in FIGS. 4 and 5.

Although the door sections 300 are shown hinged directly to the door frame 206, it should be appreciated that the door sections 300 may be coupled directly to the horizontal panels 200. In this embodiment, the door frame 206 is not required.

The access door 208 may include a handle 304, as shown in FIGS. 3 and 4. The handle 304, as shown, is a recessed handle. The recessed handle allows the access door 208 to be substantially flat on the outside surface. Thus, when the access door 208 is in the closed position, as shown in FIG. 3, the outer surface of the access door 208, the handle 304, and the horizontal panels 200 are in substantially the same plane. This allows the sectional garage door 104 to appear uniform from the outside of the building when the sectional garage door 104 and the access door 208 are in the closed position. Further, when the sectional garage door 104 moves to and from the closed position to the open position the door handle 304 will not interfere or get caught on the top of the opening 102. The door handle 304 operates the access door 208 as a standard handle would. When the door handle 304 is pulled, a latch (not shown) moves to release the access door 208 from the door frame 206 or the horizontal panel 200. The access door 208 is then free to pivot to the open position, allowing someone to pass through the passage 209. It is further contemplated that the handle 304 may be any conventional door handle, for example a door knob, a lever handle, or a thumb operated handle. The handle 304 may include a lock (not shown), or a separate lock may be provided, such as a bolt lock, magnetic lock, etc.

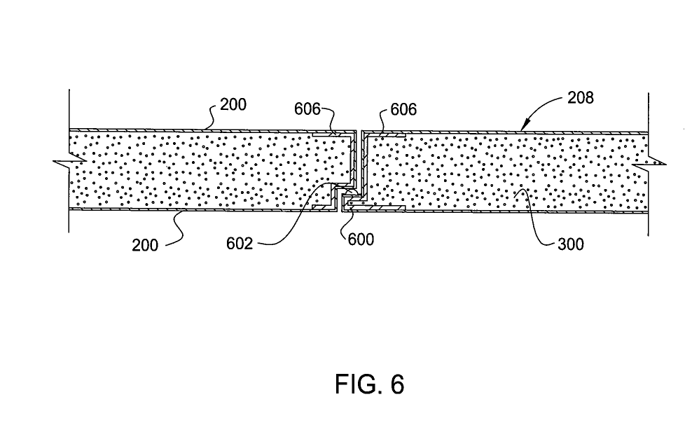

FIG. 6 shows a cross sectional view of the access door 208 and horizontal panel 200, with the access door 208 in the closed position. As shown, the door section 300 has an extended portion 600, and the horizontal panel 200 has a recessed portion 602. The extended portion 600 is adapted to fit within the recessed portion 602 when the access door 208 is in the closed position. This arrangement prevents rain and wind from entering the building 100 when the sectional garage door 104 and the access door 208 are in the closed position. Further, the edges of both the door sections 300 and the horizontal panels 200 may have a weather stripping 606 adapted to enhance the seal between the access door 208 and the horizontal panel 200. Although the horizontal panel 200 is shown as having the recessed portion, it should be appreciated that the recessed portion 602 could be on a door frame 206, or that the recessed portion 602 may be on the access door 208, with the extended portion 600 on the horizontal panel 200.

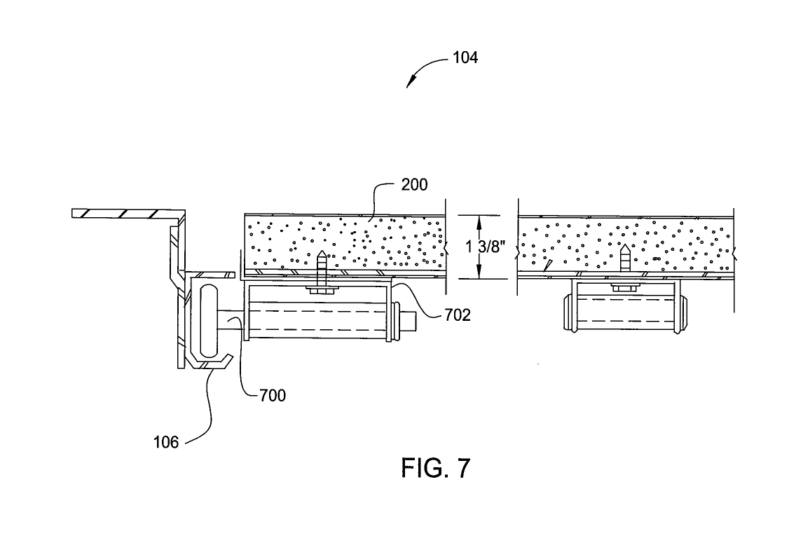

The sectional garage door 104 may include rollers 700, shown in FIG. 7, adapted for supporting and guiding the sectional garage door 104 as it moves to and from the open position to the closed position. The rollers 700 have a bracket 702 which couples to the horizontal panels 200. The brackets 702 allow the rollers 700 to rotate while preventing the rollers 700 from moving vertically or horizontally relative to the horizontal panels 200. The rollers 700 are guided in the track 106 as the sectional garage door 104 moves to and from the open position to the closed position. Further, the rollers 700 transfer gravity, impact and/or wind loading from the horizontal panels 200 to the track 106, thereby supporting the sectional garage door 104. Typically there are two rollers 700 on each end of each horizontal panel 200; however, any number may be used.

In one embodiment, the sectional garage door 104 has a controller 800. The controller 800 may be adapted to control the sectional garage door 104 and/or the access door 208. Further, the controller may be a safety mechanism. The controller may be programmable and contain a mass storage device. The access door 208 may be provided with a contact 802, shown schematically. The contact 802 is in communication with the controller 800, via communication path 804. The communication path 804 may be a wired or wireless communication path, such as inferred, blue tooth, etc. The contact 802 sends a signal to the controller 800 which indicates whether the access door 208 is in the closed or the open position. In one embodiment, the controller 800 is programmed to prevent the sectional garage door 104 from opening when the access door 208 is not in the closed position. The controller 800 may be in communication with a first opener 805, via communication path 804, for opening and closing the sectional garage door 104 and/or a second opener 807 for opening and closing the access door 208. The second opener 807 may be in communication with the latch of the handle 304 at the access door 208. Thus the second opener 807 may release the latch and open the access door 208. The controller 800 is adapted to receive signals from a control panel 806. The control panel 806 may be in wired or wireless communication with the controller 800. The control panel 806 may be adapted to be secured to the interior/exterior of the building 100, and/or be remotely located, for example in a car. The control panel 806 sends a control signal to the controller 800. The controller 800 then performs the task required by the signal. The control panel 806 may include two buttons, a first button 808 for operating the sectional garage door 104 and a second button 810 for operating the access door 208. Thus, an operator may open and close the access door 208 remotely by pushing the second button 810. The operator may then push the first button 808 in order to open the sectional garage door 104. If the access door 208 is in the open position when the operator pushes the first button 808, the controller 800 may prevent the sectional garage door 104 from moving. The controller 800 may further be adapted to send a signal to a security system when either the access door 208 and/or the sectional garage door 104 are not in the closed position.

In an alternative embodiment, a mechanical lock out device (not shown) is provided for preventing the sectional garage door 104 from opening when the access door 208 is not closed. The mechanical lockout device may include lock, such as a bar or rod, that intersects an aperture (not shown) in the track 106, similar to a traditional sectional garage door lock. The lock could have an actuator coupled to the door frame 206. When the access door 208 opens the actuator pushes the lock through the aperture, thereby preventing the sectional garage door 104 from opening. In yet another alternative embodiment, mechanical lock may be a rod or bar that intersects at least one of the horizontal axis 202 between the horizontal panels 200 when the access door 208 is in the open position. Further, any mechanical device for preventing the sectional garage door 104 from opening when the access door is open may be provided.

The access door 208 may be manufactured with the sectional garage door 104 as one unit. Further, the access door 208 may be retrofitted on any existing sectional garage door 104. This allows a user to add an access door 208 to a building 100 without having to modify the structure of the building 100.

In operation, the access door 208 and sectional garage door 104 are installed into the building. A user may approach the building 100 from the exterior of the building 100 when the opening 102 is obstructed by the sectional garage door 104 and the access door 208. If the user chooses to enter the building 100 without opening the sectional garage door 104, the user may use the access door 208. The user may use the control panel 806 to automatically open the access door 208 using the second opener 807, or manually manipulate the handle 304 to open the access door 208. As the user, or the second opener 807, moves the access door 208, the hinges 400 allow the access door 208 to pivot about the vertical axis 302 relative to the sectional garage door 104. The continued pivoting of the access door 208 creates the passage 209. The user may then walk through the passage 209 and gain access to the interior of the building 100. Because the passage 209 is relatively small compared to the opening 102, the loss of climate controlled air in the building is minimal. The user may close the access door 208, thereby preventing the elements or other people access to the interior of the building 100. With the access door 208 closed, the user may open the sectional garage door 104. The user, either manually or using the first opener, may lift the sectional garage door 104. As the sectional garage door 104 moves up, the rollers 700, coupled to the horizontal panels 200, guide the horizontal panels along the track 106. The uppermost rollers 700 then encounter the bend in the track 106. The bend allows the rollers 700 to transition from the vertical section to the horizontal section of the track 106. As the rollers 700 encounter the bend, the horizontal panels 200 pivot relative to one another about each of the horizontal axis 202. The pivoting of the horizontal panels 200 causes the horizontal hinges 500 to pivot, thereby allowing the door sections 300 to pivot and move with the horizontal panels 200. Each of the horizontal panels 200 and door sections 300 pivot around the bend in the track 106 until the sectional garage door 104 is in the open position. Once in the open position, the user may move large equipment into and out of the building 100. The process may be repeated in order to close the sectional garage door 104. Further, the steps in the process may be in any order depending on the requirements of the user.

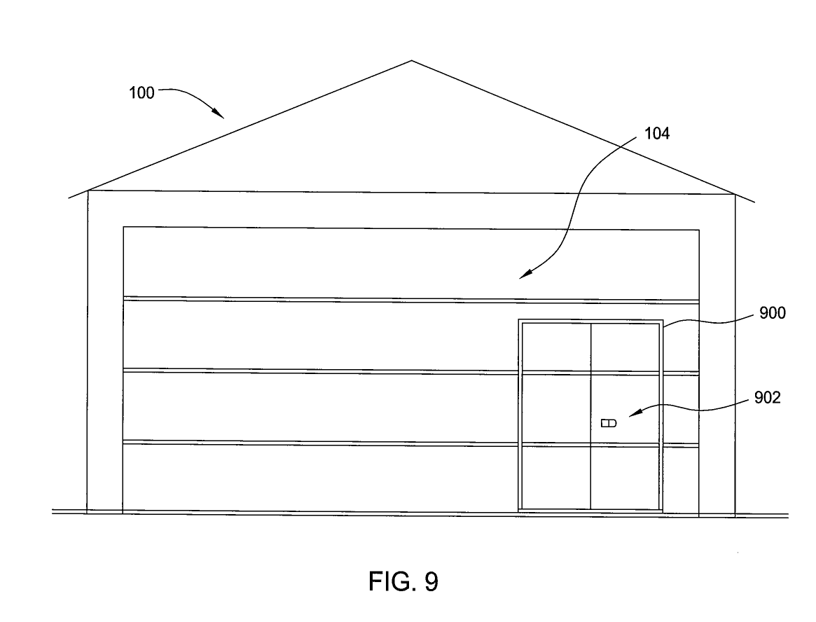

In an alternative embodiment, the sectional garage door 104 includes an oversized passage 900 which houses an oversized access door(s) 902. The oversized access door(s) 902 operate in a similar manner to the access door 208 described above; however, the oversized access door(s) 900 is adapted to create a larger opening in the sectional garage door 104. As shown in FIG. 9, the oversized access door(s) 902 is French doors; however, it should be appreciated that the oversized access door(s) 902 may be a single door, or any other arrangement. The oversized access door(s) 902 may be adapted to the specific size of equipment to be placed inside the building 100. For example, the oversized passage 900 may be adapted to accommodate a golf cart through the passage 900. Thus, the golf cart may be placed into the building without opening the sectional garage door 104. Further, the oversized passage may be specifically sized to accommodate other items, for example but not limited to motorcycles, scooters, bicycles, tractors, lawn mowers, industrial equipment, and/or fork lifts.

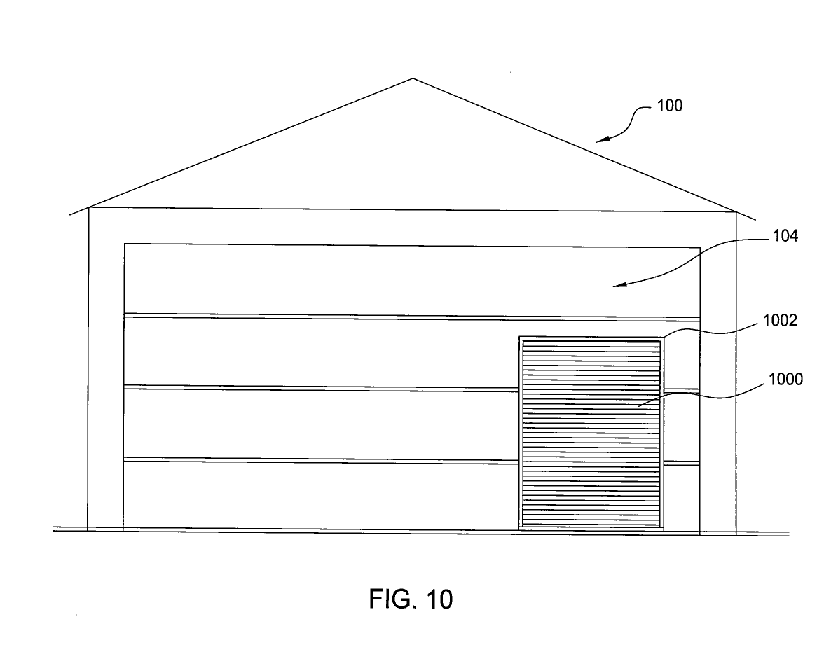

In an alternative embodiment, the access door 208 or 902 is replaced with a roll up access door 1000, as shown in FIG. 10. The roll up access door 1000 has a track (not shown) that is coupled to the horizontal panels 200 or the door frame 206. The roll up access door 1000 opens by rolling up toward the top of the passage 1002.

In yet another embodiment, the access door 208 is a Dutch door (not shown). The Dutch door allows the opening of only the top half or only the bottom half of the door 208.

In yet another embodiment, the sectional garage door 104 includes more than one access door 208 and/or 902.

The access door 208 and sectional garage door 104 may include standard door items, including but not limited to molding (not shown), ornamentation (not shown), windows (not shown), etc.

In an alternative embodiment, the access door 208 may have a separate screen door (not shown). The screen door would prevent insects from entering through the passage 209 when the access door 208 is in the open position. The screen door may be a roll up screen attached to one side of the door frame 206 or a conventional screen door. The conventional screen door would require a hinge or flexible joint near the flexible joint 210 of the door frame 206. Further, the screen door would have hinges which attach the screen door to the door frame 206 in a manner similar to the hinges 400.

While the foregoing is directed to embodiments of the present invention, other and further embodiments of the invention may be devised without departing from the basic scope thereof, and the scope thereof is determined by the claims that follow.

1. An access door for use within a sectional garage door, the access door comprising:
two or more door panels;
a first set of hinges, wherein the first set of hinges pivotably couples the door panels to a door frame, wherein the door frame is coupled to the sectional garage door and the first set of hinges enable the access door to pivot from a first position substantially coplanar to the sectional garage door to a second position extending at an angle from the sectional garage door, wherein in the second position a passage through the sectional garage door is created; and
a second set of hinges, wherein at least one hinge of the second set of hinges is located between two abutting door panels and the second set of hinges are configured to allow the door panels to pivot about a substantially horizontal axis as the sectional garage door moves between a closed position and an opened position.

2. The access door of claim 1, further comprising a door handle coupled to the access door, wherein the door handle is adapted to move the access door between the first position and the second position while the sectional garage door is in the closed position.

3. The access door of claim 1, wherein the first set of hinges are two or more continuous hinges.

4. The access door of claim 1, wherein the second set of hinges are continuous hinges.

5. The access door of claim 3, wherein the first set of hinges bias the access door toward the first position.

6. The access door of claim 1, wherein the passage has a minimum width of 2 feet and a minimum height of 5 feet and 6 inches.

7. The access door of claim 1, wherein the sectional garage door consists of a plurality of horizontal panels that span the entire length of an opening in a building.

8. The access door of claim 7, wherein the door frame is an integral part of at least some of the plurality of horizontal panels.

9. The access door of claim 1, further comprising a control panel configured to remotely move the door from the first position to the second position.

10. The access door of claim 9, wherein the control panel is further configured to remotely move the sectional garage door from the closed position to the opened position.

11. The access door of claim 10, further comprising a first opener adapted to move the sectional garage door from the closed position to the opened position, wherein the first opener is operated using the control panel.

12. The access door of claim 11, further comprising a second opener adapted to move the access door from the first position to the second position, wherein the second opener is operated using the control panel.

13. The access door of claim 1, further comprising a screen door covering the access door.

14. A sectional garage door, comprising:
a plurality of horizontal sections, each horizontal section coupled to the adjacent horizontal section by a plurality of hinges;
two or more tracks which guide the plurality of horizontal sections from a first position to a second position, wherein in the first position the plurality of horizontal sections substantially cover an opening of a building, and wherein in the second position the horizontal sections do not cover the opening;
a plurality of connectors for connecting the plurality of horizontal sections to the two or more tracks;
a door frame formed within the sectional garage door, wherein the door frame spans at least a portion of two of the horizontal sections, the door frame having a flexible joint near each intersection of the horizontal section which the door frame spans; and
an access door formed in the plurality of horizontal sections coupled to the door frame, the access door configured to have an open position and a closed position wherein in the open position the door frame creates a passage into an interior of the building when the sectional garage door is in the first position and in the closed position the access door blocks access to the interior of the building.

15. The sectional garage door of claim 14, wherein the flex joint is a hinge.

16. The sectional garage door of claim 14, wherein the door frame and the access door are large enough to allow a golf cart to enter the building.

17. The sectional garage door of claim 16, wherein the door comprises two access doors which are hinged to two opposing sides of the door frame.

18. The sectional garage door of claim 14, wherein the access door is coupled to the door frame by a series of vertical hinges coupled to the door frame and the access door.

19. The sectional garage door of claim 18, the vertical hinges are continuous hinges which span substantially the height of the horizontal panel to which the door frame is coupled.

20. The sectional garage door of claim 14, further comprising an automatic access door opener for moving the access door between the opened position and the closed position.

21. The sectional garage door of claim 20, further comprising a sectional garage door opener configured to move the sectional garage door between the first position and the second position.

22. The sectional garage door of claim 21, further comprising a remote control adapted to operate the access door opener.

23. The sectional garage door of claim 22, wherein the remote control is further adapted to operate the sectional garage door opener.

24. The sectional garage door of claim 14, further comprising an alarm system comprising one of more contacts adapted to send a signal in the event the access door is not in the closed position.

25. The sectional garage door of claim 14, further comprising a locking mechanism configured to inhibit the sectional garage door from moving while the access door is not in the closed position.

26. The sectional garage door of claim 25, wherein the locking mechanism is an electronic lock.

27. The sectional garage door of claim 14, further comprising a latch configured to hold the access door in the closed position and release the access door from the closed position.

28. The sectional garage door of claim 14, further comprising a door handle configured to allow an operator to open and close the access door, wherein the door handle is recessed into the access door.

29. The sectional garage door of claim 14, wherein the door frame includes a foot plate configured to rest on the ground when the sectional garage door is in the first position and to support the lower most horizontal section and wherein the foot plate is substantially flat thereby allowing an operator to enter the building without having to step high over the foot plate.

30. A method of entering a building through a sectional garage door wherein the sectional garage door has a plurality of horizontal panels pivotably coupled to one another about a horizontal axis, the method comprising:
closing the sectional garage door thereby substantially covering an opening into the building;
pivoting an access door about a substantially vertical axis wherein the access door is hinged to two or more of the horizontal panels;
creating a passage through the sectional garage door by pivoting the access door; and
walking through the passage.
